(19) United States
(12) Patent Application Publication
(10) Pub. No.: US 2002/0058447 A1
(43) Pub. Date: May 16, 2002

(54) Crimp-type terminal and method of producing crimp-type terminal

(76) Inventors: Takayoshi Endo, Shizuoka (JP); Satoshi Yamada, Shizuoka (JP)

Correspondence Address: Sughrue Mion Zinn Macpeak & Seas PLLC, 2100 Pennsylvania Avenue NW, Washington, DC, 20037, US

(21) Appl. No.: 09/514,319

(22) Filed: Feb. 28, 2000

(30) Foreign Application Priority Data
Feb. 26, 1999 (JP) P.HEI 11-049692

(51) Int. Cl. H01R 4/10

(52) U.S. Cl. 439/878

(57) ABSTRACT

In a crimp-type terminal, an electrically-conductive member is provided on an inner surface of a conductor clamping portion for press-clamping a conductor portion Wa of a wire W. A production method includes the step in which a narrow, elongated electrically-conductive member is applied to a surface of a terminal parent material (see FIG. 2) before the terminal parent material is blanked.

### BACKGROUND OF THE INVENTION

This invention relates to a crimp-type terminal, having a conductor clamping portion for press-clamping a conductor portion of a wire, and also to a method of producing this crimp-type terminal.

FIG. 7 shows a common crimp-type terminal 1, and this crimp-type terminal 1 includes an electrical contact portion 2 for electrical contact with a mating connection portion, and a wire clamping portion 3 extending from the electrical contact portion 2 so as to press-clamp a wire W. The wire clamping portion 3 includes a conductor clamping portion 4 for press-clamping a conductor (core) portion Wa of the wire W, and a sheath clamping portion 5 for press-clamping a sheath Wb of the wire W. The conductor clamping portion 4 is pressed to embrace the conductor portion Wa while the sheath clamping portion 5 is pressed to embrace the sheath Wb.

In the above construction, it has been confirmed that if the height of the conductor clamping portion 4 of the crimp-type terminal 1 (that is, a crimp height (C/H) CH (see FIG. 8)) increases, a resistance of a conductor-clamped portion increases. The reason for this is that the size of many gaps 6, formed when the conductor clamping portion 4 is pressed to grip the conductor portion Wa, is varied depending on the crimp height CH, and an off-specification (off-standard) value of the crimp height CH is a factor in the instability of the resistance value.

This is clearly indicated in a graph (FIG. 9) showing the relation between the crimp height and the resistance of the conductor-clamped portion.

Namely, the initial resistance (the resistance after the production; the ordinate axis), as well as the resistance after the heating (the resistance after a heat test; the ordinate axis), increases with the increase of the crimp height CH represented by the abscissa axis, and particularly a change (increase) of the resistance after the heating is more conspicuous than a change (increase) of the initial resistance. The resistance after the heating is varied in the range indicated by lines in the direction of the ordinate axis.

Therefore, in the production of the crimp-type terminal 1, the dimensional control of the crimp height CH is important, and in order to secure the reliability of the crimp-type terminal 1, it is necessary to narrow the range d (set to one graduation in the graph of FIG. 9) of the standard value of the crimp height CH although this control is cumbersome.

### SUMMARY OF THE INVENTION

This invention has been made in view of the above problems, and an object of the invention is to provide a crimp-type terminal and a method of producing this crimp-type terminal, in which the reliability of the terminal is high, and the control of a production process is easy.

In order to achieve the above object, the present invention provides a crimp-type terminal having a conductor clamping portion for press-clamping a conductor portion of a wire including, an electrically-conductive member formed in inner surface on said conductor clamping portion which contact with said conductor portion of said wire.

In the invention of above mention, the conductor clamping portion and the conductor portion can be held in intimate contact with each other through the electrically-conductive member. When the electrically-conductive member is filled in the gaps between the conductor clamping portion and the conductor portion, the conductor-clamped portion is in a gas-tight condition, so that the increase and variations of a resistance at this conductor-clamped portion are reduced. And besides, the range of a standard value of a crimp height is increased, so that the process control is easy.

Therefore, there can be provided the crimp-type terminal which has the high reliability, and is easy in process control.

In order to achieve the above object, the invention provides a method of producing a crimp-type terminal, produced by a plurality of developed crimp-type terminal blanked out from a terminal parent material, having a conductor clamping portion for press-clamping a conductor portion of a wire including, applying a narrow, elongated electrically-conductive member to a portion of a surface of said terminal parent material, which is to define an inner surface of said conductor clamping portion, before blanking said terminal parent material.

In the invention of the above mention, the method includes the above step, and therefore when the wire is clamped after the terminal parent material is blanked, the conductor clamping portion and the conductor portion can be held in intimate contact with each other through the electrically-conductive member, and therefore the increase and variations of the resistance at this conductor-clamped portion are reduced. And besides, the range of the standard value of the crimp height is increased, so that the process control is easy.

Therefore, there can be provided the method of producing the crimp-type terminal which has the high reliability, and is easy in process control.

### BRIEF DESCRIPTION OF THE DRAWINGS

FIG. 1 is a perspective view of one preferred embodiment of a crimp-type terminal of the present invention, showing a conductor-clamped portion.

FIG. 2 is a plan view of a terminal parent material (for producing the crimp-type terminals of FIG. 1) having an electrically-conductive material applied thereof.

FIG. 3 is a cross-sectional view taken along the line B-B of FIG. 2.

FIG. 4 is a plan view of the terminal parent material of FIG. 2 subjected to blanking.

FIG. 5 is a cross-sectional view taken along the line A-A of FIG. 1.

FIG. 6 is a graph showing the relation between a crimp height and a resistance of the conductor clamped portion.

FIG. 7 is a perspective view of a conventional crimp-type terminal, showing a conductor-clamped portion.

FIG. 8 is a cross-sectional view taken along the line C-C of FIG. 7.

FIG. 9 is a graph showing the relation between a crimp height and a resistance of the conductor clamped portion of the conventional terminal.

FIG. 10 is a plan view of a terminal parent material in which the terminals are serially connected together (for producing the crimp-type terminals of FIG. 1) having an electrically-conductive material applied thereof.

FIG. 11 is a plan view of a terminal parent material (for producing the crimp-type terminals of FIG. 1) having an electrically conductive material intermittently applied thereof.

FIG. 12 is a perspective view of a crimp-type terminal of the present invention, showing a conductor-clamped portion for connecting conductor portion of wires together.

### DERAILED DESCRIPTION OF PREFERRED EMBODIMENTS

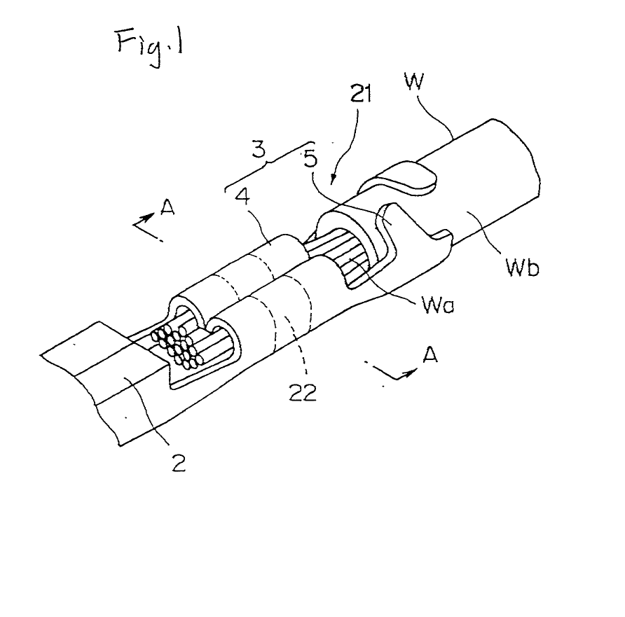

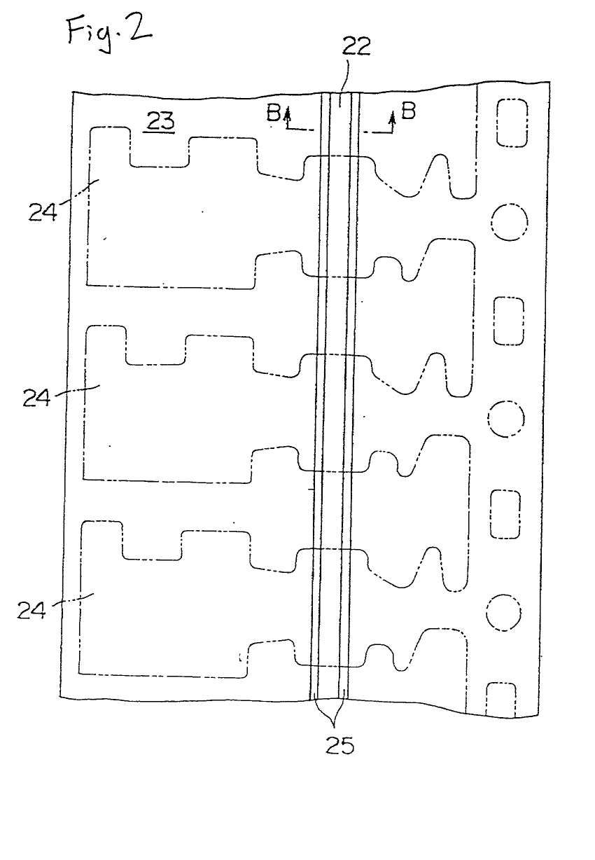

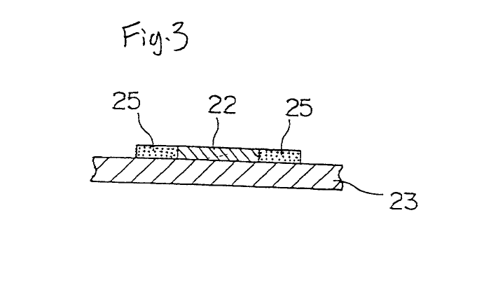

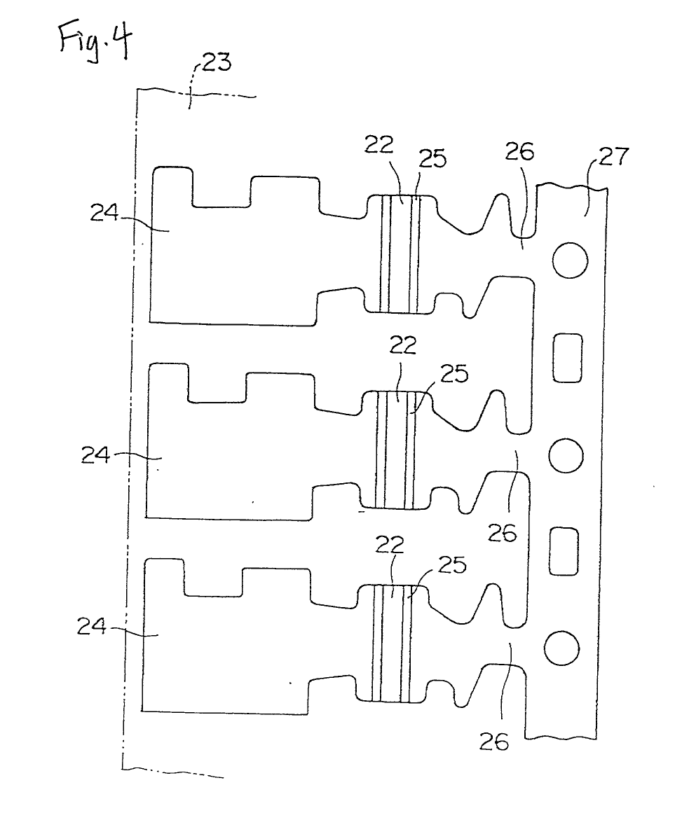

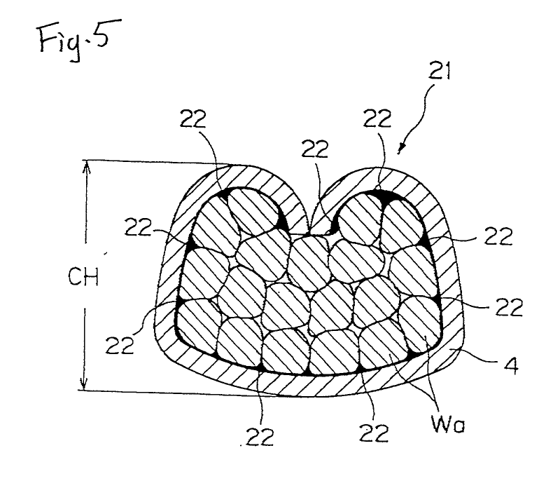

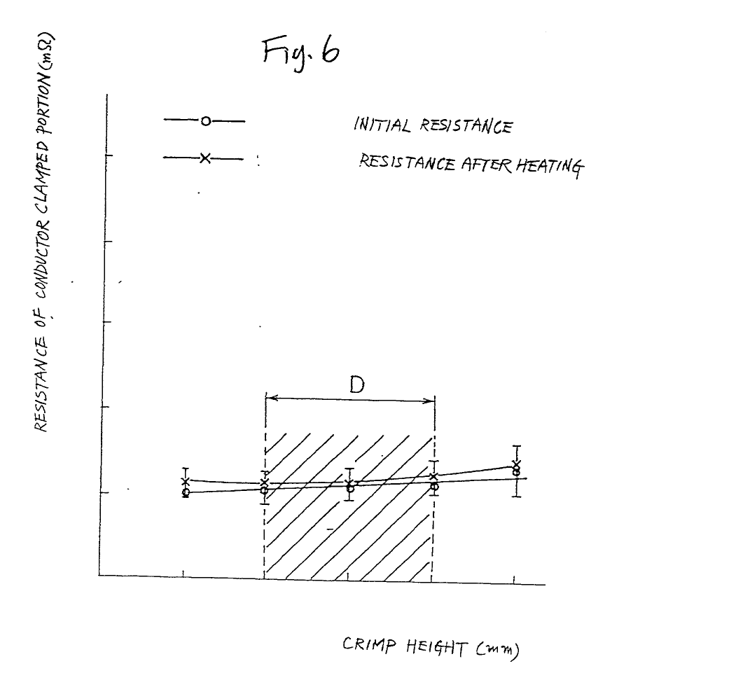

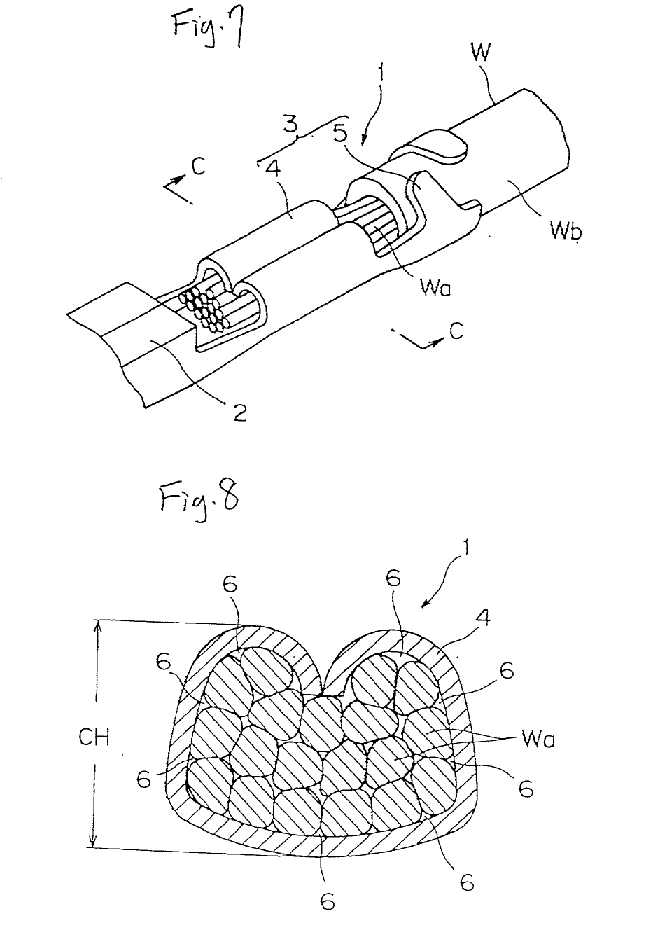

One preferred embodiment of the present invention will now be described with reference to the drawings. FIG. 1 is a perspective view of one preferred embodiment of a crimp-type terminal of the invention, showing a conductor-clamped portion. Those constituent portions, basically identical to those of the conventional terminal, will be designated by identical reference numerals, respectively, and detailed description thereof will be omitted.

First, the construction of the crimp-type terminal 21 will be described.

Like the conventional terminal, the crimp-type terminal 21 includes an electrical contact portion 2 and a wire clamping portion 3, and the wire clamping portion 3 includes a conductor clamping portion 4 for press-clamping a conductor (core) portion Wa of the wire W, and a sheath clamping portion 5 for press-clamping a sheath Wb of the wire W.

A narrow, elongated electrically-conductive member 22 is formed on an inner surface of the conductor clamping portion 4, and extends over an entire width thereof. This electrically-conductive member 22 is filled gas-tight in gaps which are formed between the conductor clamping portion 4 and the conductor portion Wa when a press-clamping operation is effected.

Next, a method (process) of producing the crimp-type terminal 21 will be described with reference to FIGS. 2 to 4. For producing the crimp-type terminals 21, the electrically-conductive member 22 (see FIG. 2) is applied or bonded to a terminal parent material 23 before blanking this terminal parent material 23, that is, before a plurality of crimp-type terminals 24 in a developed condition are blanked out from the terminal parent material 23.

The electrically-conductive member 22 is bonded to that portion of the surface of the terminal parent material 23, which is to define the inner surface of the conductor clamping portion 4 (see FIG. 1), and this electrically-conductive member 22 in a narrow, elongated form extends in a direction of interconnection of the developed crimp-type terminals 24 (that is, in an upward-downward direction in FIG. 2).

As shown in FIG. 3, the electrically-conductive member 22 comprises a narrow elongated member integral with narrow elongated adhesive portions 25, and this electrically-conductive member 22 is bonded to the surface of the terminal parent material 23 as is the case with a commercially-available adhesive double coated tape or a commercially-available adhesive coated seal. The electrically-conductive member 22 may include a paste of silver, a paste of copper or the like, and it can be applied to the terminal parent material by other means (such as coating) than the bonding operation. Preferably, an electrically-conductive filler is contained in the adhesive 25.

After the electrically-conductive member 22 is applied to the terminal parent material 23, the terminal parent material 23 is blanked as shown in FIG. 4. Thereafter, each developed crimp-type terminal 24 is pressed, thereby producing the crimp-type terminal 21 shown in FIG. 1.

Reference numeral 26 denotes a connecting portion, and reference numeral 27 denotes a carrier. Those portions of the terminal parent material, which are not necessary in the production, are discarded or re-used.

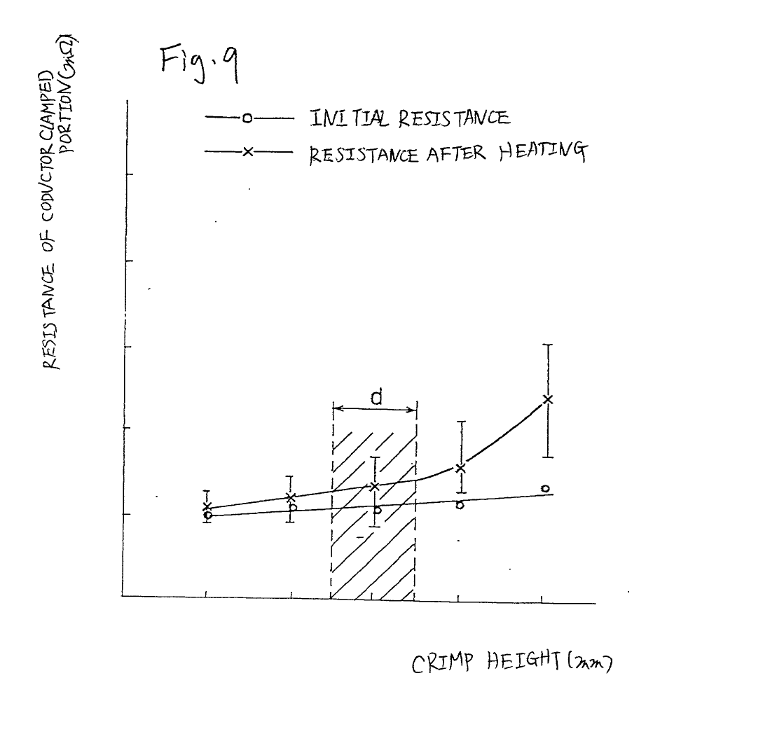

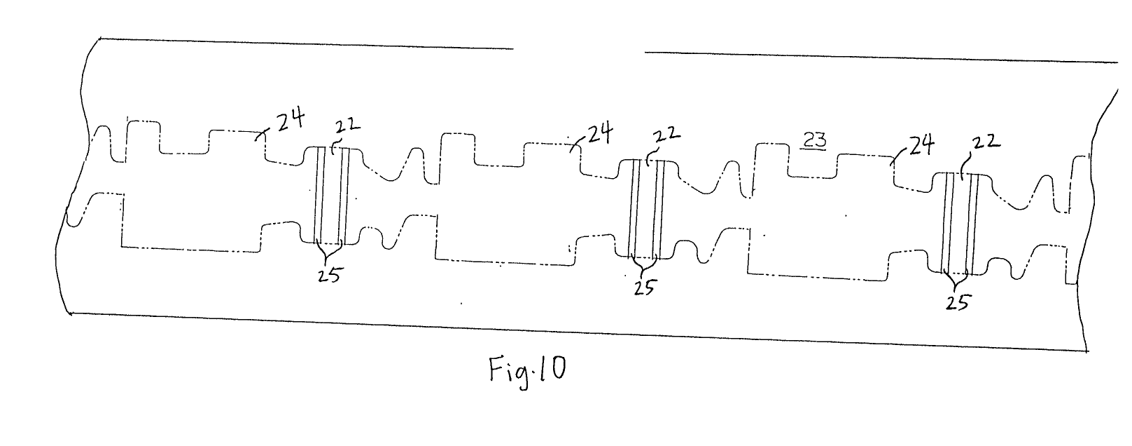

When observing the cross-section of the terminal-clamped portion of the thus produced crimp-type terminal 21, it will be appreciated that the electrically-conductive member 22 is filled gas-tight in a region (where the gaps (see FIG. 8) are formed in the conventional terminal) of contact between the conductor clamping portion 4 and the conductor portion Wa. And besides, the increase and variations of the resistance of the conductor-clamped portion are reduced, and the range D (set to two graduations in FIG. 6) of the standard value of the crimp height CH (see FIG. 5), which ensures the performance, can be made larger than that of the conventional terminal (D>d). Therefore, the control of the process is naturally easy.

Various modifications can be made without departing from the scope of the present invention.

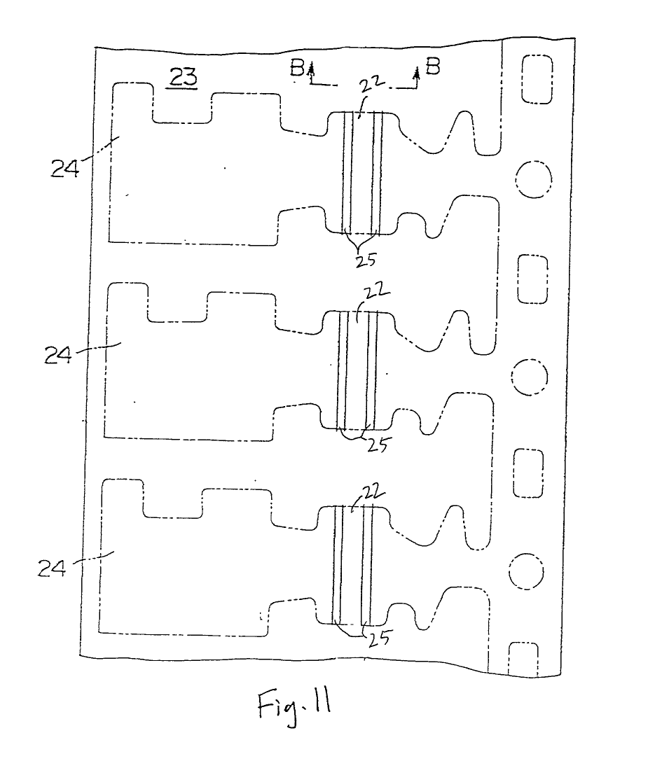

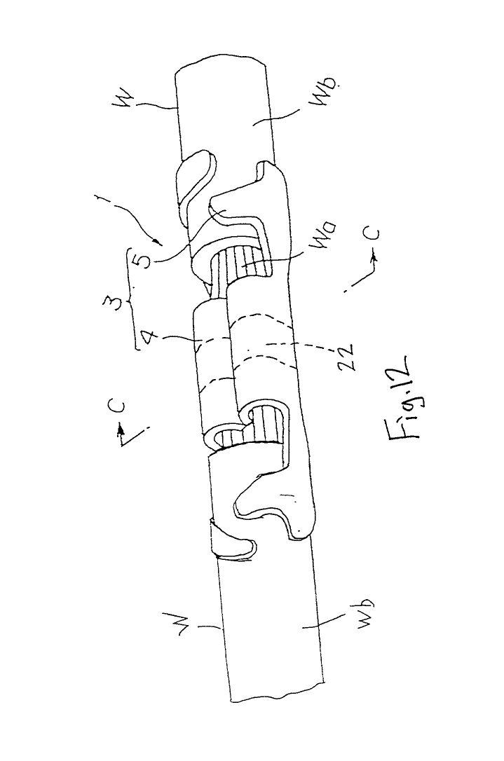

Although the production method, in which the terminals are connected together in parallel relation, has been described, there can be used a method in which the terminals are serially connected together (see FIG. 10). Although the electrically-conductive member may be intermittently applied to the terminal parent material (see FIG. 11). Although the crimp-type terminal in the drawings is of the female type, it may be of the male type. The above-mentioned electrically-conductive member 22 can be applied to a band-like member for connecting conductor portions of wires together (see FIG. 12).

As described above, the crimp-type terminal has the conductor clamping portion for press-clamping the conductor portion of the wire, and the electrically-conductive member for being filled in gaps, formed between the conductor clamping portion and the conductor portion when clamping the conductor portion, is provided on the inner surface of the conductor clamping portion. Therefore, the conductor clamping portion and the conductor portion can be held in intimate contact with each other through the electrically-conductive member. When the electrically-conductive member is filled in the gaps between the conductor clamping portion and the conductor portion, the conductor-clamped portion is in a gas-tight condition, so that the increase and variations of the resistance at this conductor-clamped portion are reduced. And besides, the range of the standard value of the crimp height is increased, so that the process control is easy.

Therefore, advantageously, there can be provided the crimp-type terminal which has the high reliability, and is easy in process control.

Further, the invention provided the method of producing the crimp-type terminal having the conductor clamping portion for press-clamping the conductor portion of the wire, which method comprises the step in which the narrow, elongated electrically-conductive member is applied to that portion of the surface of the terminal parent material, which is to define the inner surface of the conductor clamping portion, before blanking the terminal parent material. Therefore, when the wire is clamped after the terminal parent material is blanked, the conductor clamping portion and the conductor portion can be held in intimate contact with each other through the electrically-conductive member, and therefore the increase and variations of the resistance at this conductor-clamped portion are reduced. And besides, the range of the standard value of the crimp height is increased, so that the process control is easy.

Therefore, there can be provided the method of producing the crimp-type terminal which has the high reliability, and is easy in process control.

What is claimed is:

1. A crimp-type terminal having a conductor clamping portion for press-clamping at least one wire conductor portion, comprising:
an electrically-conductive member formed in an inner surface on said conductor clamping portion, said electrically-conductive member contacting said conductor portion of said wire.

2. A crimp-type terminal according to claim 1, wherein said electrically-conductive member is filled in gaps formed between said conductor clamping portion and said conductor portion when said conductor clamping portion clamps said conductor portion.

3. A method of producing a crimp-type terminal having a conductor clamping portion for press-clamping at least one wire conductor portion, said method comprising the step of:
applying an electrically-conductive member onto a portion of a surface of a terminal parent material, said portion corresponding in location to an inner surface of at least one crimp-type terminal to be out from said terminal parent material;
blanking out at least one developed crimp-type terminal from said terminal parent material.

4. A method of producing a crimp-type terminal according to claim 3, wherein an adhesive portion is provided at both sides of said electrically-conductive member.

5. A method of producing a crimp-type terminal according to claim 4, wherein an electrically-conductive filler is contained in said adhesive portion.

6. A method of producing a crimp-type terminal according to claim 4, wherein said electrically-conductive member and said adhesive portion is formed integrally.

7. A method of producing a crimp-type terminal according to claim 3, wherein said step of applying includes applying said electrically-conductive member to continuously extend across adjacent two of said at least one crimp-type terminal to be blanked out.

8. A method of producing a crimp-type terminal according to claim 7, wherein said step of blanking-out includes blanking out said adjacent two of said at least one crimp-type terminals so that said adjacent two of said at least one crimp-type terminals are arranged in parallel.

9. A method of producing a crimp-type terminal according to claim 3, wherein said step of applying includes intermittently applying said electrically-conductive member to separately located on adjacent two of said at least one crimp-type terminal to be blanked out.

10. A method of producing a crimp-type terminal according to claim 9, wherein said step of blanking-out includes blanking out said adjacent two of said at least one crimp-type terminals so that said adjacent two of said at least one crimp-type terminals are arranged in parallel.

11. A method of producing a crimp-type terminal according to claim 9, wherein said step of blanking-out includes blanking out said adjacent two of said at least one crimp-type terminals so that said adjacent two of said at least one crimp-type terminals are arranged in serially.
